(19) United States
(12) Patent Application Publication
(10) Pub. No.: US 2013/0156174 A1
(43) Pub. Date: Jun. 20, 2013

(54) SYSTEM AND METHOD FOR PROVIDING TELEPHONE NUMBER RELATED INFORMATION, AND PROGRAM PRODUCT THEREOF

(71) Applicants: CHIEN-FU KUO, Taipei City (TW); JHENG-HUAN SONG, Taipei City (TW); SHENG-FENG CHENG, Taipei City (TW); CHEN-HAO SU, Taipei City (TW)

(72) Inventors: CHIEN-FU KUO, Taipei City (TW); JHENG-HUAN SONG, Taipei City (TW); SHENG-FENG CHENG, Taipei City (TW); CHEN-HAO SU, Taipei City (TW)

(21) Appl. No.: 13/404,932

(22) Filed: Feb. 24, 2012

(30) Foreign Application Priority Data
Dec. 14, 2011 (TW) 100146090

(51) Int. Cl. H04M 11/00

(52) U.S. Cl. 379/93.02; 379/93.01

(57) ABSTRACT

A system for introducing telephone number related information, a method for introducing telephone number related information and a program product using the system and method are disclosed. An electronic communication device transmits a telephone number to a remote system for introducing telephone number related information when dialing or receiving a call, and the system searches the telephone number related information from a database stored in the system and provides the information to the electronic communication device, such that the electronic communication device can display the related information corresponding to the telephone number to let users know about the telephone number related information before receiving or dialing a call.

### CROSS-REFERENCE TO RELATED APPLICATION

This non-provisional application claims priority under 35 U.S.C. §119(a) on Patent Application No(s).100146090 filed in Taiwan, R.O.C. on Dec. 14, 2011, the entire contents of which are hereby incorporated by reference.

### FIELD OF THE INVENTION

The present invention relates to an information providing system, an information providing method and a program product thereof, in particular to the system and method for providing telephone number related information and the program product thereof.

### BACKGROUND OF THE INVENTION

As communication technology advances, the use of telephones becomes increasingly more popular and telephone becomes an indispensable part of our life. Although users can establish communication links with other people through mobile phones, networks, and other diversified channels nowadays, telephone numbers still can be used for communicating with others.

In these days, various advertising information are provided. For example, users usually receive a stranger's call such as an advertising call or an interview call from their mobile phone, and these telephone numbers cannot be identified by the users effectively, or the user usually ignore and reject these calls, so that the effectiveness of the advertising is reduced significantly, while annoying the users.

Regardless of voice or textual communications, the present existing electronic communication device that uses a telephone number cannot provide users any information about the telephone number related information.

### SUMMARY OF THE INVENTION

Therefore, it is a primary objective of the present invention to establish a center for providing telephone number related information.

Another objective of the present invention is to improve the chance of letting telephone number related information be read or listened at the user end.

A further objective of the present invention is to provide a platform for advertisers or individuals to deliver advertising information.

To achieve the aforementioned and other objectives, the present invention provides a system for providing telephone number related information applied to receive a telephone number when an electronic communication device dials or receives a call, and the system providing the telephone number related information to the electronic communication device, and the comprising: a telephone number additional information database, for storing the telephone number and additional information corresponding to the telephone number; an additional information editing module, coupled to the telephone number additional information database, for editing the telephone number and the additional information corresponding to the telephone number; and an information search module, coupled to the telephone number additional information database, for receiving the telephone number transmitted from the electronic communication device, and searching additional information corresponding to the telephone number from the telephone number additional information database and using and providing it as the telephone number related information to the electronic communication device.

In a preferred embodiment of the present invention, the system further comprises a social network server coupled to the information search module for storing the telephone number and evaluation information corresponding to the telephone number, wherein the information search module searches evaluation information corresponding to the telephone number from the social network server, and the additional information corresponding to the telephone number from the additional information database, and uses these information as the telephone number related information to be provided to the electronic communication device.

In a preferred embodiment of the present invention, the system further comprises a telephone number search number recording module coupled to the information search module for recording the number of times of the telephone number being searched.

In a preferred embodiment of the present invention, the system further comprises an account management module coupled to the additional information editing module for performing a login authentication of a user of the telephone number, and letting the user operate the additional information editing module.

To achieve the aforementioned and other objectives, the present invention further provides a method of providing telephone number related information applied in an electronic communication device to access telephone number related information from a remote system for providing telephone number related information, and the system for providing telephone number related information having at least one telephone number and the telephone number related information stored therein, and the method comprising the steps of: transmitting a telephone number to the system for providing telephone number related information when dialing or receiving a call, and the system for providing telephone number related information searching the telephone number related information; receiving the telephone number related information provided by the system for providing telephone number related information; and displaying the telephone number related information.

In a preferred embodiment of the present invention, the system for providing telephone number related information comprises a social network server, and the method further comprises the step of providing evaluation information of the telephone number to the social network server of the system for providing telephone number related information by the electronic communication device, wherein the telephone number related information includes the evaluation information.

In a preferred embodiment of the present invention, the system for providing telephone number related information comprises a telephone number additional information database, an additional information editing module and an account management module, and the method further comprises the steps of: logging in the system for providing telephone number related information through the account management module; and using the additional information editing module to edit a user telephone number and a corresponding additional information thereof; and storing the user telephone number and the corresponding additional information into the telephone number additional information database as the user telephone number related information.

To achieve the aforementioned and other objectives, the present invention further provides a program product stored in an electronic communication device for providing telephone number related information, and after the electronic communication device loads and executes the program product, the aforementioned method is completed.

The present invention creates telephone number related information in advance, so that a user can install the program product of the electronic communication device for providing telephone number related information to access telephone number related information from a database at a remote end easily, so as to improve the advertising effectiveness significantly and provide the telephone number related information for the for users' reference.

### BRIEF DESCRIPTION OF THE DRAWINGS

FIG. 1 is a block diagram of a system for providing telephone number related information in accordance with a preferred embodiment of the present invention;

FIG. 2 is a flow chart of a method for providing telephone number related information in accordance with a preferred embodiment of the present invention;

FIG. 3 is a block diagram of a system for providing telephone number related information in accordance with another preferred embodiment of the present invention; and

FIG. 4 is a flow chart of a method for providing telephone number related information in accordance with the other preferred embodiment of the present invention.

### DESCRIPTION OF THE PREFERRED EMBODIMENTS

The objects, characteristics and effects of the present invention will become apparent with the detailed description of the preferred embodiments and the illustration of related drawings as follows.

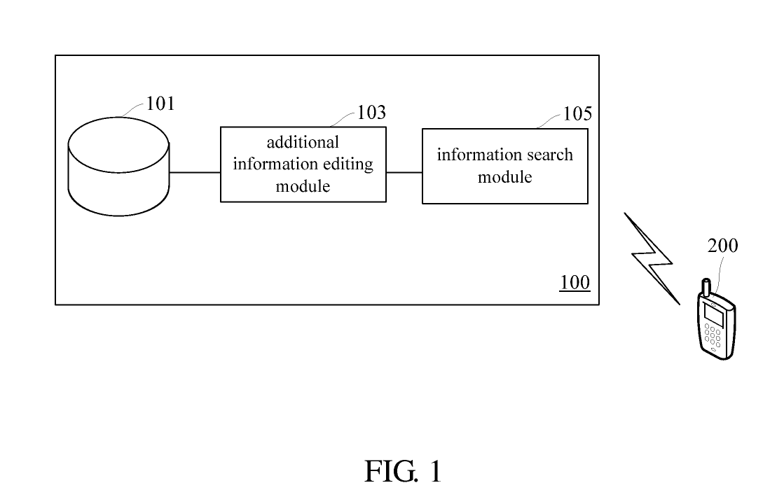

With reference to FIG. 1 for a block diagram of a system for providing telephone number related information in accordance with a preferred embodiment of the present invention, the system for providing telephone number related information is used in a center of providing telephone number related information, storing personal or commercial information, such as personal photos, bibliographies, name cards, mottos, and mood diaries, or company addresses, product photos, and recent discounts, and the information can be in form of texts, graphics, movies, or sounds and provided for an electronic communication device 200 to access the telephone number related information, and provide the information or users' reference.

The embodiment of the present invention can be applied in an electronic communication device 200 such as a mobile phone, a flat PC, a PDA Phone, a mobile Internet device (MID), a NB/Net Book/PC with the SIP/VoIP communication functions, or any other electronic communication device 200 for voice communication (such as a telephone device for Skype), and a desktop computer connected to the system for providing telephone number related information of the present invention. The present invention can be applied to any device that outputs a telephone number.

The system for providing telephone number related information 100 in accordance with a preferred embodiment of the present invention is provided for receiving a telephone number transmitted by an electronic communication device 200 when dialing or receiving a call, and the system for providing telephone number related information 100 searches and provides the telephone number related information to the electronic communication device 200. The system for providing telephone number related information 100 comprises a telephone number additional an information database 101, an additional information editing module 103 and an information search module 105.

The telephone number additional information database 101 is provided for storing at least one telephone number and additional information corresponding to the at least one telephone number. The more telephone number stored in the telephone number additional information database 101, the broader is the coverage of the related information, so that users can access the required information from the system for providing telephone number related information 100 more easily.

The additional information editing module 103 is coupled to the telephone number additional information database 101 for editing the telephone number and the additional information telephone number corresponding to the telephone number stored in the additional information database 101. The additional information editing module 103 can be used by individuals or companies to store their telephone number and edit information brought out by the telephone number.

The information search module 105 is coupled to the telephone number additional information database 101 for receiving the telephone number transmitted by the electronic communication device 200, and searching additional information corresponding to the telephone number from the telephone number additional information database 101 and using it as the telephone number related information and providing it to the electronic communication device 200. Wherein, the electronic communication device 200 is connected to the system for providing telephone number related information 100 via a cable or a wireless communication. For example, if the electronic communication device 200 is a mobile phone, the mobile phone can be connected to a wireless communication network; and if the electronic communication device 200 is a desktop computer, the computer can be connected through a cable network. A cable or wireless transceiver in the information search module 105 can be used to connect the electronic communication device 200. In FIG. 1, the wireless connection is shown. In addition, this preferred embodiment adopts the mobile phone as the electronic communication device 200 to illustrate the invention.

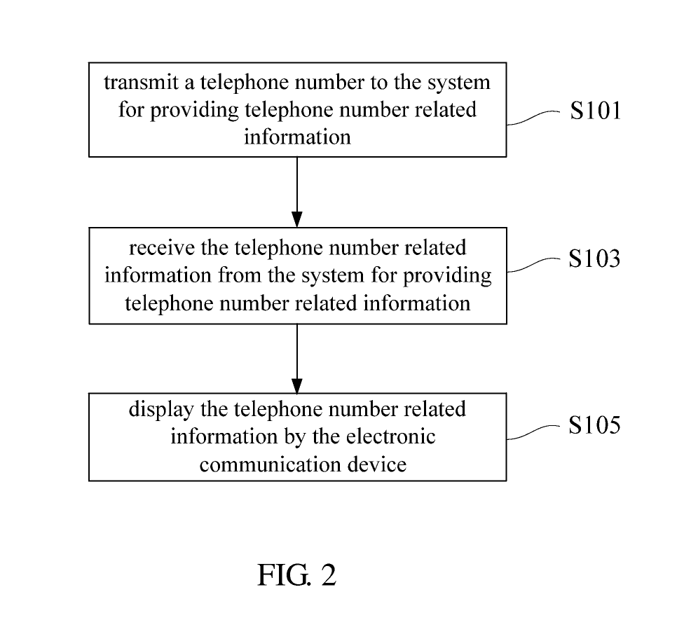

With reference to FIG. 2 for a flow chart of a method for providing telephone number related information in accordance with a preferred embodiment of the present invention, the method for providing telephone number related information is used by an electronic communication device 200 to access telephone number related information from a remote system for providing telephone number related information 100, and the method comprises the following steps:

S101: Transmit a telephone number to the system for providing telephone number related information 100, when an electronic communication device 200 dials or receives a call, such that the telephone number can be provided for the system for providing telephone number related information 100 to search telephone number related information from the electronic communication device 200.

S103: Transmit the telephone number related information, if the system for providing telephone number related information 100 has searched the related information, such that the electronic communication device 200 can receive the telephone number related information from the system for providing telephone number related information 100.

S105: Display the telephone number related information by the electronic communication device 200.

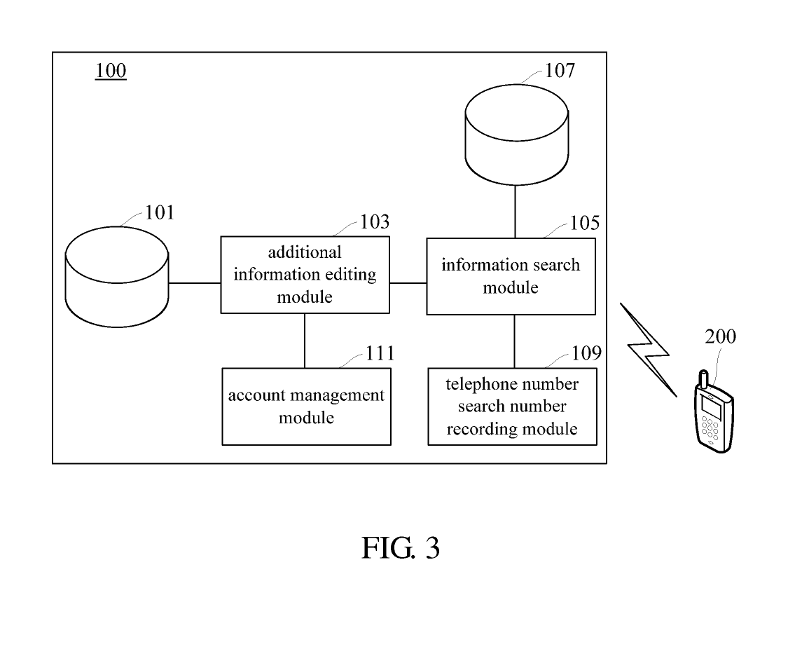

With reference to FIG. 3 for a block diagram of a system for providing telephone number related information in accordance with another preferred embodiment of the present invention, the system for providing telephone number related information 100 comprises a social network server 107, a telephone number search number recording module 109, an account management module 111, and their combinations.

The social network server 107 is coupled to the information search module 105 for storing the telephone number and the evaluation information corresponding to the telephone number. Wherein, the information search module 105 of the system for providing telephone number related information 100 searches evaluation information corresponding to the telephone number from the social network server 107, and the additional information corresponding to the telephone number from the additional information database 101, and these information are used as the telephone number related information and provided to the electronic communication device 200. In addition, the electronic communication device 200 also provides the evaluation information corresponding to the telephone number to the social network server 107 of the system for providing telephone number related information 100, wherein the telephone number related information includes the evaluation information.

The telephone number search number recording module 109 is coupled to the information search module 105 for recording the number of times of the telephone number being searched. In other words, the module provides the number of times of retrieving the telephone number related information. For example, when the system for providing telephone number related information 100 is used as an advertising information publication platform, the number of times counted by the telephone number search number recording module 109 can be used as a basis for charging the advertising.

The account management module 111 is coupled to the additional information editing module 103 and provided for the login authentication of users or companies, and provided for storing telephone numbers and related information into the telephone number additional information database 101 of the user or company in order to operate the additional information editing module 103, so as to maintain the desired information to be disclosed to the user of a particular telephone number. When the electronic communication device 200 of a user or a company is connected to the information search module 105, the user or company must pass the authentication of the account management module 111 first before the user or company can edit the information.

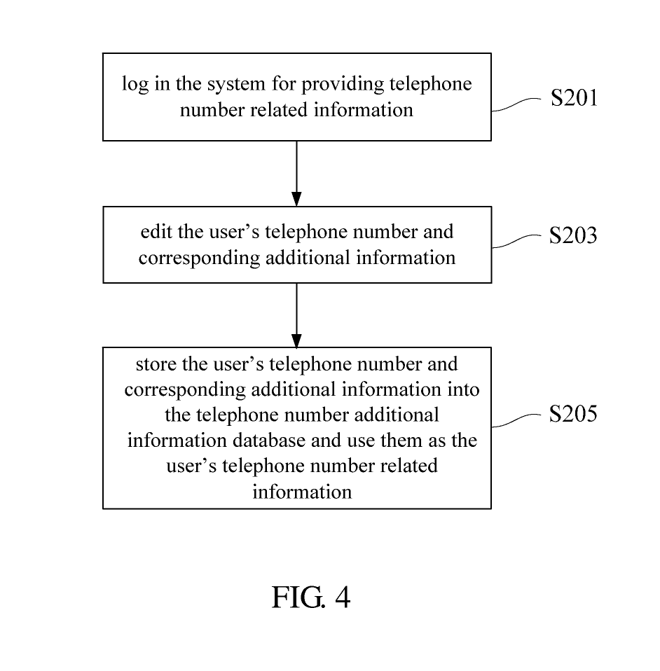

With reference to FIG. 4 for a flow chart of a method for providing telephone number related information when a user log in the system in accordance with a preferred embodiment of the present invention, the method comprises the following steps:

S201: Use an electronic communication device 200 to log in the system for providing telephone number related information 100 through the account management module 111 by a user.

S203: Use the additional information editing module 103 to edit the user's telephone number and corresponding additional information.

S205: Store the user's telephone number and corresponding additional information into the telephone number additional information database 101 and use them as the user's telephone number related information.

In another preferred embodiment, the aforementioned method is implemented into a program product of an electronic communication device program, such that a contacted telephone number is transmitted to a remote system for providing telephone number related information 100 when dialing or receiving a call, and the telephone number related information can be accessed. In other words, after the electronic communication device has loaded and executed the program, the steps of the foregoing preferred embodiments are completed. For example, the program product is an application program provided for users to download or save into the electronic communication device 200, so that the aforementioned method can be implemented after the program is installed.

The aforementioned embodiments of the present invention can be applied to a network phone or a device with a network phone account as well. For example, if a user makes a call via a Skype account (regardless of dialing or receiving a call), the user can use the system for providing telephone number related information, method and program product in accordance with the aforementioned embodiments of the present invention. Wherein, the aforementioned telephone number is the Skype account number, and related information corresponding to the Skype account numbers are stored in the telephone number additional information database.

In summation of the description above, the present invention creates the telephone number related information in advance and provides the information to an electronic communication device of a user, so that the user can have more information to determine the background information of an incoming call (when receiving a call) or an outgoing call (when dialing a call).

While the invention has been described by means of specific embodiments, numerous modifications and variations could be made thereto by those skilled in the art without departing from the scope and spirit of the invention set forth in the claims.

What is claimed is:

1. A system for providing telephone number related information, applied to receive a telephone number when an electronic communication device dials or receives a call, and the system providing the telephone number related information to the electronic communication device, and the system comprising:
a telephone number additional information database, for storing the telephone number and additional information corresponding to the telephone number;
an additional information editing module, coupled to the telephone number additional information database, for editing the telephone number and the additional information corresponding to the telephone number; and
an information search module, coupled to the telephone number additional information database, for receiving the telephone number transmitted from the electronic communication device, and searching additional information corresponding to the telephone number from the telephone number additional information database and using and providing it as the telephone number related information to the electronic communication device.

2. The system of claim 1, further comprising a social network server coupled to the information search module for storing the telephone number and evaluation information corresponding to the telephone number, wherein the information search module searches evaluation information corresponding to the telephone number from the social network server, and the additional information corresponding to the telephone number from the additional information database, and uses these information as the telephone number related information to be provided to the electronic communication device.

3. The system of claim 1, further comprising a telephone number search number recording module coupled to the information search module for recording the number of times of the telephone number being searched.

4. The system of claim 1, further comprising an account management module coupled to the additional information editing module for performing a login authentication of a user of the telephone number, and letting the user operate the additional information editing module.

5. A method for providing telephone number related information, applied in an electronic communication device to access telephone number related information from a remote system for providing telephone number related information, and the system for providing telephone number related information having at least one telephone number and the telephone number related information stored therein, and the method comprising the steps of:
transmitting a telephone number to the system for providing telephone number related information when dialing or receiving a call, and the system for providing telephone number related information searching the telephone number related information;
receiving the telephone number related information provided by the system for providing telephone number related information; and
displaying the telephone number related information.

6. The method of claim 5, wherein the system for providing telephone number related information comprises a social network server, and the method further comprise the step of providing evaluation information of the telephone number to the social network server of the system for providing telephone number related information by the electronic communication device, wherein the telephone number related information includes the evaluation information.

7. The method of claim 5, wherein the system for providing telephone number related information comprises a telephone number additional information database, an additional information editing module and an account management module, and the method further comprises the steps of:
logging in the system for providing telephone number related information through the account management module; and
using the additional information editing module to edit a user telephone number and a corresponding additional information thereof; and storing the user telephone number and the corresponding additional information into the telephone number additional information database as the user telephone number related information.

8. A program product stored in an electronic communication device for providing telephone number related information, and after the electronic communication device loads and executes the program product, the method of claim 5 is completed.
